(19) United States
(12) Patent Application Publication
(10) Pub. No.: US 2017/0209964 A1
(43) Pub. Date: Jul. 27, 2017

(54) SOLDER BALL AND ELECTRONIC MEMBER

(71) Applicants: NIPPON STEEL & SUMIKIN MATERIALS CO., LTD., Tokyo (JP); NIPPON MICROMETAL CORPORATION, Saitama (JP)

(72) Inventors: Shinichi TERASHIMA, Tokyo (JP); Shinji ISHIKAWA, Tokyo (JP); Naoya SAWAKI, Tokyo (JP); Keisuke AKASHI, Saitama (JP)

(21) Appl. No.: 15/329,746

(22) PCT Filed: Jul. 9, 2015
(86) PCT No.: PCT/JP2015/069802

§ 371 Date: Jan. 27, 2017

(30) Foreign Application Priority Data
Jul. 31, 2014 (JP) 2014-156057

(51) Int. Cl. B23K 35/26; C22C 13/00

(52) U.S. Cl. CPC B23K 35/262; B23K 35/26; C22C 13/00

(57) ABSTRACT

Provided are a solder ball having extremely excellent drop impact resistance and an electronic member comprising the solder ball. The solder ball of the present invention contains Ni in an amount of from 0.04 to 0.2% by mass and the balance is Sn and incidental impurities, and Cu is not more than a detection limit of the ICP analysis. Hence, it is possible to provide the solder ball having extremely excellent drop impact resistance and an electronic member comprising the solder ball.

### TECHNICAL FIELD

The present invention relates to a solder ball for semiconductor mounting, and an electronic member comprising the solder ball.

### BACKGROUND ART

Electronic components are mounted on a printed wiring board or the like. The mounting of electronic components is generally performed by a so-called reflow method. In the reflow method, a printed wiring board or the like is temporarily joined with the electronic components with solder balls for semiconductor mounting (hereinafter referred to as “solder balls”) and flux, and then the solder balls are melted by heating the entire printed wiring board, and the solder balls are then solidified by cooling the printed wiring board to room temperature, and thereby a strong solder joint portions (simply referred to as (solder) joints) are ensured.

In an electronic device incorporating electronic members each having a plurality of electronic components mutually joined with the joints (solder balls), when a current for operation of the electronic device is applied to the electronic device, the current generates heat in the electronic device. The solder balls connect materials, such as a silicon chip and a resin substrate, which have different thermal expansion coefficients, and hence, during the operation of the electronic device, the solder balls are subjected to a thermal fatigue environment. As a result, a fissure, referred to as a crack, progresses in the solder ball, which may hinder the transmission and reception of electric signals through the solder ball. The reliability of the solder ball in the thermal fatigue environment is commonly referred to as the thermal fatigue reliability or TCT (Thermal Cycling Test) characteristic, and is considered as one of the important characteristics required for the solder ball (see, for example, Patent Literature 1).

### CITATION LIST

### Patent Literature

Patent Literature 1: Japanese Patent Laid-Open No. 5-50286

### SUMMARY OF INVENTION

### Technical Problem

However, for example, in a solder ball for BGA (Ball Grid Array), a solder ball for CSP (Chip Scale Package), or the like, whose use has been increasing rapidly in recent years, it is also important to secure the drop impact resistance (hereinafter may be referred to as a drop characteristic) meaning that the electronic device does not become defective when the electronic device is dropped unexpectedly. In some cases, the excellent drop impact resistance of the electronic device is more important than the excellent TCT characteristic.

In view of the above-described problems, an object of the present invention is to provide a solder ball having excellent drop impact resistance, and to provide an electronic member comprising the solder ball.

### Solution to Problem

A solder ball of the present invention contains Ni in an amount of from 0.04 to 0.2% by mass, and the balance is Sn and incidental impurities, and Cu is not more than a limit of detection (detection limit) of ICP analysis.

An electronic member of the present invention comprises electronic components mutually connected by joints, and at least one of the joints is formed by the solder ball.

### Advantageous Effects of Invention

According to the present invention, it is possible to achieve a solder ball having extremely excellent drop impact resistance and to achieve an electronic member comprising the solder ball.

### DESCRIPTION OF EMBODIMENTS

Unlike a conventional solder ball made of Sn—Cu—Ag type alloy, in which Sn is contained as a main component and Cu and Ag are contained to improve the TCT characteristics, a solder ball of the present invention puts importance on the improvement of the drop impact resistance (drop characteristic), rather than the improvement of the TCT characteristics. The solder ball of the present invention contains Sn as a main component. The solder ball contains Ni in an amount of from 0.04 to 0.2% by mass and a remainder (the balance) is Sn and incidental impurities. With such a composition, excellent improvement in the drop impact resistance of the solder ball is achieved.

In the present invention, in the manufacturing process of the solder ball, an optimum content of Ni is added to Sn, and Ni is present as Ni₃Sn₄ in the solder ball. In a case where a solder joint is formed, by using the reflow method, with a solder ball on an electrode made of Cu, Sn in the melted solder ball and solid Ni₃Sn₄ react simultaneously with Cu of the electrode, and thereby, the solid Ni₃Sn₄ is decomposed so that Ni of Ni₃Sn₄ participates in the reaction between Sn and Cu. As a result, an intermetallic compound made of (Cu, Ni)₆Sn₅, (Cu, Ni)₃Sn, or the like is formed along the interface between the melted solder ball and the electrode.

The intermetallic compound made of (Cu, Ni)₆Sn₅, (Cu, Ni)₃Sn, or the like has a relatively slow growth rate, and hence, a smooth intermetallic compound layer which has a small thickness and small unevenness is formed between the solder ball and the electrode. Thus, after the solder ball is mounted on the electrode, a relatively ductile intermetallic compound, such as (Cu, Ni)₆Sn₅ or (Cu, Ni)₃Sn, which has a small thickness, is formed between the solder ball and the electrode. Therefore, the intermetallic compound and its vicinity can be deformed in a ductile manner and brittle fracture of the solder joint is unlikely to occur even when external shock is applied to the solder joint, so that excellent drop impact resistance of the solder joint is secured. After the solder ball is mounted on the electrode, a smooth intermetallic compound layer, which has small unevenness that includes peninsula (or island)-shaped protrusions, is formed between the solder ball and the electrode. Therefore, the uneven portions, in which external shock applied to the solder joint tends to be concentrated, is small, and hence, the shock is correspondingly dispersed without being concentrated. As a result, the occurrence of cracks in the intermetallic compound layer is suppressed, and the drop impact resistance is significantly improved. In order to obtain the effect of improving the drop impact resistance, it is most effective that Ni in the form of Ni₃Sn₄ is present in the solder ball in the manufacturing process (or before mounting) of the solder ball.

For example, when Ni is added to a raw material of the solder ball made of Sn—Cu—Ag type alloy in which Cu is contained in view of securing the solder wettability, as is conventional, Ni is combined with Cu in the solder ball, so that a compound made of (Cu, Ni)₆Sn₅ or (Cu, Ni)₃Sn is formed in the solder ball before mounting, and thereby, Ni is consumed correspondingly.

In the solder ball in which the compound made of (Cu, Ni)₆Sn₅ or (Cu, Ni)₃Sn is formed before mounting, when the solder joint is formed by the reflow method on the electrode made of Cu, Ni cannot be diffused from (Cu, Ni)₆Sn₅ or (Cu, Ni)₃Sn because the growth rate of the compound made of (Cu, Ni)₆Sn₅ or (Cu, Ni)₃Sn is slow. As a result, it is difficult that Ni is involved in the reaction between Sn and Cu forming the electrode. Therefore, even when Ni is added to the solder ball in which Cu is mixed in Sn, as is conventional, it is difficult to form the smooth intermetallic compound layer with small thickness between the melted solder ball and the electrode at the time of mounting.

For this reason, in the solder ball of the present invention, it is desired that Cu in the Sn—Ni type alloy, containing Sn and a predetermined amount of Ni, is not more than a limit of detection (detection limit) of the ICP (Inductively Coupled Plasma) analysis, that is, Cu is not contained in the solder ball. It should be noted that the ICP analysis refers to ICP emission spectroscopic analysis or ICP mass spectrometry. Here, “not more than detection limit” means that the detection amount is not more than the detection limit of the ICP emission spectroscopic analysis or the ICP mass spectrometry. In the solder ball of the present invention, the content of Cu is not more than the detection limit of the ICP analysis, and hence (Cu, Ni)₆Sn₅ and (Cu, Ni)₃Sn are less likely to be formed in the solder ball before mounting, so that the excellent drop impact resistance is obtained correspondingly.

In the solder ball of the present invention, a Sn—Ni type alloy does not contain Cu, but contains Ni in an amount of from 0.04 to 0.2% by mass, preferably 0.04% or more and less than 0.1% by mass, or more preferably in a range of 0.06±0.02% by mass, and hence an excellent effect of improving the drop impact resistance is achieved. When the content of Ni is less than 0.04% by mass, the formation of (Cu, Ni)₆Sn₅ or (Cu, Ni)₃Sn is difficult, and the desired drop impact resistance cannot be obtained. When the content of Ni is more than 0.2% by mass, needle-like Ni₃Sn₄ is coarsely grown in the solder ball, so that the desired drop impact resistance is not obtained, and hence it is preferred that the amount of Ni is in a range from 0.04 to 0.2% by mass. When the content of Ni is less than 0.1% by mass, a further excellent effect of improving the drop impact resistance is obtained, and hence, it is preferred that the amount of Ni is less than 0.1% by mass. Further, it is most preferred that the amount of Ni is in a range of 0.06±0.02% by mass.

In producing the solder ball of the present invention, the predetermined amount of Ni is added to Sn, and in addition, one or more of Mg, P, and Ga in a total amount of 0.006% or less by mass may be added. That is, the solder ball of the present invention may contain Ni in an amount of from 0.01 to 0.2% by mass (preferably 0.04% or more and less than 0.1% by mass, more preferably 0.06±0.02% by mass), and one or more of Mg, P, and Ga in a total amount of 0.006% or less by mass, and the balance (remainder) is Sn and incidental impurities.

By adding (or containing) one or more of Mg, P, and Ga in a total amount of from 0.0001 to 0.006% by mass, the wettability of the solder ball and the effect of improving the drop impact resistance are improved, as compared with those in the case where only Ni is added (or contained). The effect of improving the wettability of the solder ball is considered to be due to the fact that, for example, Mg is a metal less noble than Sn and hence is oxidized preferentially to Sn, and thereby, an amorphous oxide layer is formed in a quenching state to suppress the growth of Sn oxide on the surface of the solder ball. This effect cannot be obtained when the total content of one or more of Mg, P, and Ga is less than 0.0001% by mass. On the contrary, when the total content of one or more of Mg, P, and Ga is more than 0.006% by mass, Mg, P, or Ga is severely oxidized, so that the solder ball is not formed into a spherical shape but is formed into a polygonal shape, which is not preferable.

The solder ball of the present invention may contain Ag in an amount of from 0.1 to 1.5%, and preferably 0.5% or less by mass. That is, the solder ball of the present invention may contain Ni in an amount of from 0.01 to 0.2% by mass (preferably 0.04% or more and less than 0.1% by mass, and more preferably 0.06±0.02% by mass) and Ag in an amount of from 0.1 to 1.5% by mass, and the balance is Sn and incidental impurities. When Ag in the amount of from 0.1 to 1.5% by mass is contained in the solder ball, the occurrence of voids is sufficiently suppressed while the solder ball is hardened by Ag₃Sn precipitated in the solder ball, so that the effect of improving the TCT characteristic is obtained. Similar to the above, the solder ball containing Ag in the above amount may contain one or more of Mg, P, and Ga in a total amount of 0.006% or less by mass, and specifically, in a total amount of 0.0001 to 0.006% by mass.

The solder ball of the present invention which has the composition of Sn—Ni—Ag type alloy contains Ag in the above amount and one or more of Mg, P, and Ga in the above amount. Hence, even when Ag is contained for improving the TCT characteristic, the reduction in the drop impact resistance is prevented by the effect of Mg, P, or Ga, and thus the desired excellent drop impact resistance is obtained.

The solder ball of the present invention may contain Bi in an amount of from 0.1 to 1.5% by mass. That is, the solder ball of the present invention may contain Ni in an amount of from 0.01 to 0.2% by mass (preferably 0.04% or more and less than 0.1% by mass, and more preferably 0.06±0.02% by mass) and Bi in an amount of from 0.1 to 1.5% by mass, and the balance is Sn and the incidental impurities. When the solder ball contains Bi in the amount of from 0.1 to 1.5% by mass, the whole solder ball is hardened by solid solution strengthening due to Bi in Sn. As a result, thermal fatigue reliability of the solder ball is improved. Similar to the above, the solder ball containing Bi in the above amount may contain one or more of Mg, P, and Ga in a total amount of 0.006% or less by mass and specifically, in a total amount of from 0.0001 to 0.006% by mass.

As described above, in the solder ball having a composition of Sn—Ni—Bi type alloy, Bi in the above amount and one or more of Mg, P, and Ga in the above amount are contained. Therefore, even when Bi is contained for improving the TCT characteristic, the reduction in the drop impact resistance is prevented by the effect of Mg, P, or Ga, and hence desired excellent drop impact resistance is obtained.

In the solder ball of the present invention, the content of other elements such as Sb, In, Zn, As, Al and Au may be less than or equal to the detection limit of the ICP analysis. The solder ball of the present invention may contain at least one of Sb, In, Zn, As, Al and Au. In this case, it is preferred that the solder ball of the present invention contains at least one of Sb, In, Zn, As, Al and Au as the incidental impurities. The incidental impurities refer to impurity elements inevitably contained in materials in manufacturing processes, such as refining and dissolution. For example, in a case where one or more of Sb, In, Zn, As, Al and Au are contained as the incidental impurities, the total content of the one or more of Sb, In, Zn, As, Al and Au is not more than 30 ppm by mass.

In the solder ball of the present invention having the above-described configuration, Ni in an amount of from 0.04 to 0.2% by mass is contained and the balance is Sn and incidental impurities, and Cu is not more than the detection limit of the ICP analysis. Hence, the solder ball joined to the electrode exhibits excellent drop impact resistance.

The solder ball of the present invention contains Ni in an amount of from 0.04 to 0.2% by mass and one or more of Mg, P, and Ga in a total amount of 0.006% or less by mass, and the balance is Sn and incidental impurities, and Cu is not more than the detection limit of the ICP analysis. Hence the solder ball joined to the electrode exhibits the excellent drop impact resistance and the improved wettability.

The solder ball of the present invention contains Ni in an amount of from 0.04 to 0.2% by mass, and Ag in an amount of from 0.1 to 1.5% by mass, and the balance is Sn and incidental impurities, and Cu is not more than the detection limit of the ICP analysis. Hence, the solder ball joined to the electrode exhibits the excellent drop impact resistance and the improved TCT characteristic.

The solder ball of the present invention contains Ni in an amount of from 0.04 to 0.2% by mass and Bi in an amount of from 0.1 to 1.5% by mass, and the balance is Sn and incidental impurities, and Cu is not more than the detection limit of the ICP analysis. Hence the solder ball joined to the electrode exhibits excellent drop impact resistance.

To evaluate the drop impact resistance (drop characteristic) of the solder balls mounted between electronic components, a drop impact resistance test is carried out as a standard test according to examples described below. Specifically, in the case where the drop impact resistance test of the solder ball of the present invention was carried out by a test method (hereinafter may be referred to as JEDEC standard test) which conforms to JESD22-b111 of JEDEC standard and which is carried out at acceleration of 1500 [G], the electric resistance value of the solder ball of the present invention was not more than the electric resistance value obtained before the drop impact resistance test, even when the drop impact was applied 80 times or more in the drop impact resistance test. As a result, it was confirmed that the solder ball of the present invention exhibits excellent drop impact resistance.

Severe drop impact test (severe test) of the solder ball of the present invention was performed under conditions more severe than those of the JEDEC standard test. When the solder ball was subjected to the severe test in which acceleration was about six times 1500 [G] the JEDEC standard test and the acceleration was applied at least 30 times or more, the electric resistance value of the solder ball was not more than the electric resistance value obtained before the drop impact resistance test. Thus, it was confirmed that the drop impact resistance of the solder ball of the present invention was significantly improved.

A method for identifying the composition of the solder ball is not limited in particular, and preferred examples of the methods include EDS (Energy Dispersive X ray Spectrometry), EPMA (Electron Probe Micro Analyzer), AES (Auger Electron Spectroscopy), SIMS (Secondary Ion-microprobe Mass Spectrometer), ICP (Inductively Coupled Plasma), GD-MASS (Glow Discharge Mass Spectrometry), XRF (X-ray Fluorescence Spectrometer), and the like, which have proven records and high accuracy.

In the case where the solder ball of the present invention is used for mounting to a semiconductor memory or is used for mounting in the vicinity of a semiconductor memory, there is also a possibility that, when α-rays are emitted from the joint formed by the solder ball, the α-rays act on the semiconductor memory to erase data of the semiconductor memory. Therefore, in view of the effect of α-rays on the semiconductor memory, the solder ball of the present invention may have a so-called low α-ray dose (a low α-ray amount): 1 [cph/cm²] or less, which dose is smaller than the usual dose. The solder ball of the present invention, which has the low αray dose (a low α-ray amount), is achieved by using high-purity Sn with purity of 99.99% as a raw material, from which impurities serving as α-ray sources are removed, and by producing the solder ball having the above-described composition.

The shape of the solder ball of the present invention is not limited in particular, but a protruding shape formed by transferring a ball-shaped solder alloy onto a joint is commonly used and preferred industrially due to proven records, and the protrusion may be mounted onto another electrode.

The solder ball of the present invention is effectively used as a connection terminal of a semiconductor device of a mounting form referred to as BGA, CSP or FC (Flip Chip). In the case where the solder ball of the present embodiment is used as a connection terminal of a semiconductor device, an electronic member is obtained as follows: for example, an organic matter, such as flux and/or solder paste, is applied onto electrodes on a printed wiring board beforehand; then the solder balls are arranged on the electrodes; and thereafter firm solder joints are formed by the above-mentioned reflow method.

The electronic members of the present embodiment include an electronic member in which the solder balls of the present embodiment are mounted to a BGA, a CSP, or a FC. The electronic members of the present embodiment also include another electronic member which is formed by mounting the above-described electronic member with the solder joints to a printed wiring board as follows: flux and/or solder paste is applied onto an electrode on a printed wiring board beforehand; then the above-described electronic member with the solder joints is placed on the electrode and is firmly joined with the electrode by the above-mentioned reflow method. A flexible wiring tape referred to as a TAB (Tape Automated Bonding) tape or a metal wiring referred to as a lead frame may be used instead of the printed wiring board.

### EXAMPLES

The composition of the solder alloy forming the solder ball was changed, and the drop impact resistance (drop characteristic) and the thermal fatigue reliability (TCT characteristic) of each of the solder balls were examined. Here, raw materials, which were formed (or prepared) by adding components, such as Sn and Ni, shown in Table 1 to Table 3 below, were placed in a graphite crucible and heated to 275 [° C.] in a high-frequency melting furnace and melted, and then, were cooled, so that a solder alloy was obtained.

Thereafter, the solder alloy was formed into a wire having a wire diameter of 25 [μm]. The wire was cut into lengths of 28.79 [mm], so that the cut wires have the same volume. The cut wires were heated and melted in the high-frequency melting furnace and then cooled, so that solder balls each having a diameter of 300 [μm] were obtained. The composition of each of solder balls of examples 1 to 37 (shown as “E1” to “E37” in Table 1), examples 38 to 49 (shown as “E38” to “E49” in Table 2), and comparison examples 1 to 9 (shown as “CE1” to “CE9” in Table 3) was measured by ICP emission spectroscopic analysis. Plasma conditions were set to high-frequency output of 1.3 [KW], and the integration time of emission intensity was set to 3 seconds. A standard solution for a calibration curve of each element and a standard solution of each element, which were prepared beforehand, were used, and the elements were identified by the calibration curve method. The compositions were obtained as shown in Table 1 to Table 3. The compositions are expressed in ppm by mass in Table 1 to Table 3. For example, 10000 ppm by mass corresponds to 1% by mass. In the following descriptions, “ppm by mass (mass ppm)” shown in Table 1 to Table 3 is described in unit of “% by mass (mass %)”.

TABLE 1

| Chemical composition | | | | | | | | Drop test | | | |
|---|---|---|---|---|---|---|---|---|---|---|---|
| Sn and | | | | | | | | JEDEC | | | TCT |
| incidental | | | | | | | | STD. | Severe test | | test |
| impurities | Ag | Cu | Bi | Ni | Ga | Mg | P | evalua- | number | evalua- | evalua- |

| | [mass %] | [mass ppm] | | | | tion | of times | tion | tion |
|---|---|---|---|---|---|---|---|---|---|
| E1 | remainder | 400 | | | | ◯ | 40 | ⊚ | Δ |
| E2 | remainder | 500 | | | | ◯ | 40 | ⊚ | Δ |
| E3 | remainder | 900 | | | | ◯ | 41 | ⊚ | Δ |
| E4 | remainder | 1000 | | | | ◯ | 35 | ◯ | Δ |
| E5 | remainder | 1500 | | | | ◯ | 33 | ◯ | Δ |
| E6 | remainder | 2000 | | | | ◯ | 31 | ◯ | Δ |
| E7 | remainder | 400 | 20 | | | ◯ | 47 | ⊚◯ | Δ |
| E8 | remainder | 500 | 10 | | | ◯ | 47 | ⊚◯ | Δ |
| E9 | remainder | 500 | 20 | | | ◯ | 47 | ⊚◯ | Δ |
| E10 | remainder | 500 | 30 | | | ◯ | 47 | ⊚◯ | Δ |
| E11 | remainder | 900 | 20 | | | ◯ | 48 | ⊚◯ | Δ |
| E12 | remainder | 1000 | 20 | | | ◯ | 42 | ⊚◯ | Δ |
| E13 | remainder | 1500 | 20 | | | ◯ | 40 | ⊚ | Δ |
| E14 | remainder | 2000 | 20 | | | ◯ | 38 | ◯ | Δ |
| E15 | remainder | 400 | | 10 | | ◯ | 46 | ⊚◯ | Δ |
| E16 | remainder | 500 | | 20 | | ◯ | 46 | ⊚◯ | Δ |
| E17 | remainder | 500 | | 10 | | ◯ | 46 | ⊚◯ | Δ |
| E18 | remainder | 500 | | 3 | | ◯ | 46 | ⊚◯ | Δ |
| E19 | remainder | 900 | | 10 | | ◯ | 47 | ⊚◯ | Δ |
| E20 | remainder | 1000 | | 10 | | ◯ | 41 | ⊚ | Δ |
| E21 | remainder | 1500 | | 10 | | ◯ | 39 | ◯ | Δ |
| E22 | remainder | 2000 | | 10 | | ◯ | 37 | ◯ | Δ |
| E23 | remainder | 400 | | | 30 | ◯ | 45 | ⊚◯ | Δ |
| E24 | remainder | 500 | | | 20 | ◯ | 45 | ⊚◯ | Δ |
| E25 | remainder | 500 | | | 30 | ◯ | 45 | ⊚◯ | Δ |
| E26 | remainder | 500 | | | 60 | ◯ | 45 | ⊚◯ | Δ |
| E27 | remainder | 900 | | | 30 | ◯ | 46 | ⊚◯ | Δ |
| E28 | remainder | 1000 | | | 30 | ◯ | 40 | ⊚ | Δ |
| E29 | remainder | 1500 | | | 30 | ◯ | 38 | ◯ | Δ |
| E30 | remainder | 2000 | | | 30 | ◯ | 36 | ◯ | Δ |
| E31 | remainder | 500 | 20 | | 30 | ◯ | 49 | ⊚◯ | Δ |
| E32 | remainder | 900 | 20 | | 30 | ◯ | 50 | ⊚◯ | Δ |
| E33 | remainder | 1000 | 20 | | 30 | ◯ | 44 | ⊚ | Δ |
| E34 | remainder | 1500 | 20 | | 30 | ◯ | 42 | ⊚ | Δ |
| E35 | remainder | 2000 | 20 | | 30 | ◯ | 40 | ⊚ | Δ |
| E36 | remainder | 500 | | 10 | 30 | ◯ | 48 | ⊚◯ | Δ |
| E37 | remainder | 500 | 20 | 10 | 30 | ◯ | 50 | ⊚◯ | Δ |

TABLE 2

| | Chemical composition | | | | | | | | Drop test | | | |
|---|---|---|---|---|---|---|---|---|---|---|---|---|
| | Sn and | | | | | | | | JEDEC | | | TCT |
| | incidental | | | | | | | | STD. | Severe test | | test |
| | impurities | Ag | Cu | Bi | Ni | Ga | Mg | P | evalua- | number | evalua- | evalua- |
| | [mass %] | | | | [mass ppm] | | | | tion | of times | tion | tion |
| E38 | remainder | 0.3 | | | 500 | | | | ◯ | 35 | ◯ | ◯ |
| E39 | remainder | 1.2 | | | 500 | | | | ◯ | 32 | ◯ | ◯ |
| E40 | remainder | 1.5 | | | 500 | | | | ◯ | 30 | ◯ | ⊚ |
| E41 | remainder | | | 0.3 | 500 | | | | ◯ | 35 | ◯ | ⊚ |
| E42 | remainder | | | 0.7 | 500 | | | | ◯ | 32 | ◯ | ⊚ |
| E43 | remainder | | | 1.5 | 500 | | | | ◯ | 30 | ◯ | ⊚ |
| E44 | remainder | 0.3 | | | 500 | 20 | | | ◯ | 40 | ⊚ | ◯ |
| E45 | remainder | 1.2 | | | 500 | | 10 | | ◯ | 40 | ⊚ | ◯ |
| E46 | remainder | 1.5 | | | 500 | | | 30 | ◯ | 40 | ⊚ | ⊚ |
| E47 | remainder | | | 0.3 | 500 | 20 | | | ◯ | 40 | ⊚ | ⊚ |
| E48 | remainder | | | 0.7 | 500 | | 10 | | ◯ | 40 | ⊚ | ⊚ |
| E49 | remainder | | | 1.5 | 500 | | | 30 | ◯ | 40 | ⊚ | ⊚ |

TABLE 3

| | Chemical composition | | | | | | | | Drop test | | | |
|---|---|---|---|---|---|---|---|---|---|---|---|---|
| | Sn and | | | | | | | | JEDEC | | | TCT |
| | incidental | | | | | | | | STD | Severe test | | test |
| | impurities | Ag | Cu | Bi | Ni | Ga | Mg | P | evalua- | number | evalua- | evalua- |
| | [mass %] | | | | [mass ppm] | | | | tion | of times | tion | tion |
| CE1 | remainder | | | | | | | | ◯ | 10 | X | X |
| CE2 | remainder | | | | 300 | | | | ◯ | 12 | X | X |
| CE3 | remainder | | | | 2100 | | | | ◯ | 9 | X | X |
| CE4 | remainder | | 0.5 | | 500 | | | | ◯ | 26 | X | Δ |
| CE5 | remainder | 0.3 | 0.5 | | 500 | | | | ◯ | 23 | X | Δ |
| CE6 | remainder | 3.0 | 0.5 | | | | | | X | 3 | X | ⊚ |
| CE7 | remainder | 1.6 | | | 500 | | | | X | 22 | X | ⊚ |
| CE8 | remainder | 3.0 | | | 500 | | | | X | 7 | X | ⊚ |
| CE9 | remainder | 3.0 | 0.5 | | 500 | | | | X | 4 | X | ⊚ |

Each of the examples 1 to 6 shows a solder ball of the present invention containing Ni in an amount of from 0.04 to 0.2% by mass and the balance (remainder) being Sn and incidental impurities, and Cu is not more than the detection limit of the ICP analysis. Each of the examples 7 to 25 and the examples 27 to 36 shows a solder ball of the present invention containing Ni in an amount of from 0.04 to 0.2% by mass and the total content of one or more of Mg, P, and Ga is 0.005% or less by mass. The balance is Sn and incidental impurities, and Cu is not more than the detection limit of the ICP analysis. Each of the examples 26 and 37 shows a solder ball of the present invention containing Ni in an amount of from 0.04 to 0.2% by mass and the total content of one or more of Mg, P, and Ga is 0.006% or less by mass. The balance is Sn and incidental impurities, and Cu is not more than the detection limit of the ICP analysis.

Each of the examples 38 to 40 shows a solder ball of the present invention containing Ni in an amount of 0.05% by mass and Ag in an amount of from 0.1 to 1.5% by mass, and the balance is Sn and incidental impurities, and Cu is not more than the detection limit of the ICP analysis. Each of the examples 41 to 43 shows a solder ball of the present invention containing Ni in an amount of 0.05% by mass and Bi in an amount of from 0.1 to 1.5% by mass, and the balance is Sn and incidental impurities, and Cu is not more than the detection limit of the ICP analysis. Each of the examples 44 to 46 shows a solder ball of the present invention containing Ni in an amount of from 0.04 to 0.2% by mass and Ag in an amount of from 0.1 to 1.5% by mass, and the total content of one or more of Mg, P, and Ga is 0.006% or less by mass, and the balance is Sn and incidental impurities, and Cu is not more than the detection limit of the ICP analysis. Each of the examples 47 to 49 shows a solder ball of the present invention containing Ni in an amount of from 0.04 to 0.2% by mass and Bi in an amount of from 0.1 to 1.5% by mass, and the total content of one or more of Mg, P, and Ga is 0.006% or less by mass, and the balance is Sn and incidental impurities, and Cu is not more than the detection limit of the ICP analysis.

The drop impact resistance of each of the solder balls of the examples 1 to 49 and the comparison examples 1 to 9 was examined by the Drop test and the thermal fatigue reliability of each of the solder balls of the examples 1 to 49 and the comparison examples 1 to 9 was examined by the TCT test. Here, a printed board to which the solder ball is to be mounted has the following specifications: dimensions are 40 [mm]×30 [mm]×1 [mm]; the electrode pitch is 0.27 [mm]; the surface of the electrode is Cu electrode. After a water-soluble flux was applied onto the printed board, the solder ball was mounted on the printed board. In this state, the printed board with the solder ball was heated in the reflow furnace in which the peak temperature was kept at 250 [° C.], and then cooled, so that a solder bump was formed on the printed board.

A semiconductor device was joined onto the solder bump in a similar manner (after the water-soluble flux was applied onto the electrode on the semiconductor device, the electrode and the solder bump on the printed board were mutually positioned and were then heated in the reflow furnace in which the peak temperature was kept at 250 [° C.], and were then cooled so that the solder bump was joined onto the semiconductor device). Thereby, an electronic member having the printed board (electronic component), the solder bump (joint), and the semiconductor device (electronic component) was obtained. The semiconductor device has 8 [mm] square size and 324 pins, and the electrode is made of Cu.

The above-described electronic members formed by using the solder balls of the examples 1 to 49 and the comparison examples 1 to 9 were subjected to two types of drop impact resistance tests (Drop tests), and the drop impact resistance of each of the electronic members was evaluated. Specifically, the evaluation of drop impact resistance was performed by two types of drop impact resistance tests conforming to JESD22-b111 of JEDEC (Solid State Technology Association) standard. One of the two types of tests is a JEDEC standard test (shown as “JEDEC STD.” in Tables 1-3) which uses an impulse wave (shock wave) with the acceleration of 1500 [G] and the time width of 0.5 [ms]. The other is a severe test which applies an acceleration about six times the acceleration of the JEDEC standard, in consideration that the use environment will be more severe in the future.

The severe test was performed in such a manner that the above-described electronic member, being a test piece, was screwed on a base plate made of a stainless plate, and that the base plate was dropped from the height of 70 [cm] toward a receiving plate made of a stainless plate to collide with the receiving plate. In order to allow the base plate to fall in a horizontal position to the receiving plate, it was devised that stainless screws having a diameter of about 1 [cm] were embedded as weights on the contact surface of the base plate, which was to come into contact with the receiving plate. Generally, to obtain high acceleration, it is preferred to make metals collide with each other, and hence, in this severe test, the stainless plates were made to collide with each other. The acceleration was measured in such a manner that a commercially available accelerometer was screwed on the base plate, and that a value of the acceleration was measured with the accelerometer each time the base plate was dropped onto the receiving plate. In the severe test, the acceleration was adjusted, based on the value of the accelerometer, to be in the range of 9000 to 10000 [G], so that the acceleration was as approximately 6 times as high as the JEDEC standard of 1500 [G].

In the drop impact resistance test (Drop test), that is, in each of the JEDEC standard test and the severe test, the conductivity in the joint between the printed board and the semiconductor device of the test piece (electronic member) was checked by a conduction test each time the base plate was dropped. In this case, the electric resistance value of a portion including the joint between the printed board and the semiconductor device of the electronic member was obtained by measuring a resistance value between terminals on the printed board, which were arranged on the printed board beforehand. When the measured resistance value was more than twice the initial value obtained before the drop impact resistance test, it was determined that the electronic member was defective (broken).

In Table 1 to Table 3, the solder ball with no defect when the solder ball was dropped 80 times in the JEDEC standard test was indicated by (or evaluated as) “a single circle” (good). The solder ball in which a defect occurred when the solder ball was dropped 79 times or less was indicated by “x” (unacceptable). As shown in the Tables 1 to 3, in the JEDEC standard test, each of the solder balls of the examples 1 to 49 and the comparison examples 1 to 5 was indicated by “a single circle”, and each of the solder balls of the comparison examples 6 to 9 was indicated by “x”.

In the Tables 1 to 3, the solder ball in which a defect occurred when the solder ball was dropped 29 times or less in the severe test was indicated by “x”. The solder ball with no defect when the solder ball was dropped 30 to 39 times was indicated by “a single circle”. The solder ball with no defect when the solder ball was dropped 40 to 44 times was indicated by “a double circle” (very good). The solder ball with no defect when the solder ball was dropped 45 times was indicated by “a double circle and a single circle” (excellent). As shown in the Tables 1 to 3, in the severe test, each of the solder balls of the examples 1 to 49 was indicated by “a single circle” or better, while each of the solder balls of the comparison examples 1 to 5, which was indicated by “a single circle” in the JEDEC standard test, and the solder balls of the comparison examples 6 to 9 was indicated by “x”. Especially, it was confirmed that each of the solder balls of the examples 1 to 3, in which Ni in an amount of less than 1.0% by mass was contained, was indicated by “a double circle” in the severe test, and had drop impact resistances superior to those of the solder balls of the examples 4 to 6, in which Ni in an amount of 1.0% by mass or more was contained. On the other hand, the solder ball of the comparison example 2, in which Ni in an amount of less than 0.04% by mass was contained, and the solder ball of the comparison example 3, in which Ni in an amount of more than 0.2% by mass was contained, were indicated by “x” in the results of the severe test.

From the results of the severe test, it was confirmed that, when one or more of Mg, P, and Ga were contained, the drop impact resistance was improved. Especially, it was confirmed that, when one or more of Mg, P, and Ga were contained in the solder ball in which Ni in an amount of less than 1.0% by mass was contained, the solder ball was indicated by “a double circle and a single circle”, which is the best evaluation in the severe test, and it was also confirmed that the drop impact resistance was remarkably improved as compared with those of the solder balls of the comparison examples 1 to 9.

The above-described electronic members produced by using the solder balls of the examples 1 to 49 and of the comparison examples 1 to 9 were subjected to the TCT test, and the thermal fatigue reliability of each of the electronic members was evaluated. In the TCT test, one cycle of a series of processes, in which the test temperature was maintained at −40 [° C.] for 30 minutes and then the test temperature was maintained at 125 [° C.] for 30 minutes, was repeated for a predetermined number of times. After 25 cycles of the tests, the test piece (electronic member) was taken out from the TCT test device, and the conduction test was performed in which the electric resistance value of a portion including the joint between the printed board and the semiconductor device was obtained by measuring a resistance value between the terminals on the printed board. In the conduction test, the electronic member was determined to be defective when the electric resistance value of the electronic member was more than twice the initial value obtained before the TCT test of the electronic member. In Table 1 to Table 3, the results were shown in the column of the “TCT test”.

In the column of “TCT test” in Table 1 to Table 3, the solder ball, in which the first defect occurred on or before 200 cycles, was determined to be defective and indicated by “x”. The solder ball, in which the first defect occurred after 200 cycles and on or before 350 cycles, was determined to be in a practically usable level and indicated by “Δ” (acceptable). The solder ball, in which the first defect occurred after 350 cycles and on or before 450 cycles, was determined to be good and indicated by “a single circle”. The solder ball, in which the first defect occurred after 450 cycles, was determined to be excellent and indicated by “a double circle”. In the examples 1 to 37, the solder ball which does not contain Ag and Bi (that is, the solder ball in which Ag and Bi were not more than the detection limit of the ICP analysis) was in a practically usable level. On the other hand, in the examples 38 to 40 and 44 to 46 in which Ag was added, and in examples 41 to 43 and 47 to 49 in which Bi was added, it was confirmed, from each of the results of the TCT test, that the solder ball was indicated by “a single circle” or higher and that the TCT characteristic of the solder ball was improved.

However, in the examples 38 to 43, although the content of Ni was as small as 0.05% by mass (500 ppm by mass), the solder ball was indicated by “a single circle” in each of the results of the severe test. It was confirmed, from each of the results of the severe test, that the drop impact resistance of the solder ball was inferior to those of the solder balls of the examples 2, 9, and the like, in which the content of Ni was 0.05% by mass and which does not contain Ag and Bi. Especially, from the comparison examples 6 to 9, it was confirmed that the good drop impact resistance, which is important in the present invention, was not obtained even though the TCT characteristic of the solder ball containing Ag in an amount of more than 1.5% by mass was drastically improved. Therefore, it was confirmed that, even when the TCT characteristic was improved by adding Ag, it is preferred to contain Ag in an amount of 1.5% or less by mass. From the examples 41 to 43, it was confirmed that the solder ball containing Bi achieves improved TCT characteristic and good drop impact resistance.

On the other hand, from the examples 44 to 46, it was confirmed that the solder ball containing Ag was indicated by “a double circle” in each of the results of the severe test, as long as the solder ball contained at least one of Mg, P, and Ga. In those cases, it was confirmed that the solder ball containing Ag exhibits good drop impact resistance. From the examples 47 to 49, it was confirmed that the solder ball containing Bi was indicated by “a double circle” in the each of the results of the severe test, as long as the solder ball contains at least one of Mg, P, and Ga. In those cases, it was confirmed that the solder ball containing Bi exhibits good drop impact resistance.

From the above, it was confirmed that the thermal fatigue reliability of the joint was in a practically usable level and the drop impact resistance was drastically improved in a case where the solder ball made of a Sn—Ni type alloy, in which Cu was not contained and in which Ni in an amount of from 0.04 to 0.2% by mass was added to Sn in the manufacturing process of a solder ball, was joined to an electrode.

1. A solder ball containing Ni in an amount of from 0.04 to 0.2% by mass and the balance being Sn and incidental impurities,
wherein Cu is not more than a detection limit of ICP analysis.

2. The solder ball according to claim 1, wherein the solder ball contains one or more of P, Mg, and Ga, a total amount of the one or more of P, Mg, and Ga being 0.006% or less by mass.

3. The solder ball according to claim 1, wherein the solder ball contains Ag in an amount of from 0.1 to 1.5% by mass.

4. The solder ball according to claim 1, wherein the solder ball contains Bi in an amount of from 0.1 to 1.5% by mass.

5. The solder ball according to claim 1,
wherein the solder ball contains the Ni in an amount of more than 0.04% by mass and less than 0.1% by mass.

6. The solder ball according to claim 1,
wherein the Sn is low α ray Sn and an amount of α ray emitted from the Sn is 1 [cph/cm²] or less.

7. An electronic member comprising electronic components mutually connected by joints, wherein at least one of the joints is formed by the solder ball of claim 1.
